(19) United States
(12) Patent Application Publication
(10) Pub. No.: US 2008/0125537 A1
(43) Pub. Date: May 29, 2008

(54) Rubber mixture for inner liner of pneumatic vehicle Tires

(75) Inventor: Jens Kleffmann, Hannover (DE)

Correspondence Address: COLLARD & ROE, P.C., 1077 NORTHERN BOULEVARD, ROSLYN, NY, 11576, US

(73) Assignee: CONTINENTAL AKTIENGESELLSCHAFT

(21) Appl. No.: 12/011,342

(22) Filed: Jan. 25, 2008

Related U.S. Application Data
(63) Continuation of application No. PCT/EP2006/065841, filed on Aug. 31, 2006.

(30) Foreign Application Priority Data
Sep. 21, 2005 (DE) 10 2005 044 999.9

(51) Int. Cl. C08K 5/00

(52) U.S. Cl. 524/515; 524/496

(57) ABSTRACT

The invention relates to a rubber mixture, in particular for the inner liner of pneumatic vehicle tires. Furthermore, the invention relates to a pneumatic vehicle tire with an inner liner which is based on such a rubber mixture. For reduced plasticizer diffusion along with good compressive and tensile properties, the rubber mixture contains a) 50-100 parts by weight of at least one halobutyl rubber, b) up to a maximum of 50 parts by weight of at least one further rubber, selected from the group comprising butyl rubber, polybutadiene, styrene-butadiene copolymer, 3,4-polyisoprene, cis-1,4-polyisoprene, natural rubber, styrene-isoprene copolymer and styrene-isoprene-butadiene terpolymer, the parts by weight of a) and b) adding up to 100, c) 5-45 parts by weight, based on 100 parts by weight of a) and b), of at least one polyisobutylene with a weight-average molecular weight M_{w} of over 400 000 g/mol and d) 10-120 parts by weight, based on 100 parts by weight of a) and b), of at least one carbon black.

The invention relates to a rubber mixture, in particular for the inner liner of pneumatic vehicle tires. The invention furthermore relates to a pneumatic vehicle tire having an inner liner which is based on such a rubber mixture.

In tubeless pneumatic vehicle tires, an inner liner which is as impermeable as possible to air and is arranged radially inward, also referred to as inner core or inner plate, ensures that the air pumped into the tire does not escape. The escape of air must be counteracted since the escape leads to a reduced pressure in tires which very adversely affects the stability of the tire. Furthermore, the inner liner protects the carcass from the entrance of air and moisture by diffusion, since the strength members of the carcass and/or of the belt can be damaged by air and moisture. To ensure that the inner liner remains air-tight, it must also have good resistance to tearing and fatigue so that no tears which impair the airtightness form during driving.

Butyl rubber, chlorobutyl rubber or bromobutyl rubber, occasionally blended with other diene rubbers, are usually used as rubbers for the inner liner. Butyl and halobutyl rubbers have a low gas permeability. The blending of butyl and halobutyl rubbers with rubbers selected from the group consisting of polybutadiene, styrene-butadiene copolymer, 3,4-polyisoprene, cis-1,4-polyisoprene, natural rubber, styrene-isoprene copolymer and styrene-isoprene-butadiene terpolymer is effected in order to increase the building tack, reduce the costs and improve the mechanical properties.

By metering in bulky fillers having little or no activity, the airtightness of mixtures based on butyl or halobutyl rubber can be further increased. The fillers include, for example, carbon black type N 660 and chalk. However, since inner liners should have a low modulus of elasticity and low hardness in order to prevent tearing under dynamic stresses, but this is in contradiction to a high proportion of inactive fillers, as a rule mineral oil plasticizers which reduce the modulus of elasticity and the hardness of the mixture but at the same time also increase the gas permeability again, resulting in a narrow, optimum range for the amounts of mineral oil plasticizer and filler used, are added to the rubber mixture.

The mineral oil plasticizers may partly diffuse out of the inner liner into other tire components, some of them critical for stability, in the course of tire manufacture, for example in the vulcanization, and during storage and use. As a result, the inner liner becomes brittle with the possible result of tearing. Moreover, the components into which the mineral oil plasticizer diffuses, have a lower modulus of elasticity and hardness as a result of the plasticizer diffusing in. If components which are subject to energy- or force-constant deformation instead of elongation-constant deformation are affected by the diffusing in, for example the bead reinforcing rubber, a significant weakening with tearing in these components may result owing to the stress/strain concentration in the softened components. Use of so-called balancing powder, too, can result in plasticizer being removed from the inner liner and the latter becoming brittle.

U.S. Pat. No. 787,068 describes improved rubber mixtures for inner liners of pneumatic vehicle tires, which rubber mixtures contain polyisobutylene having an average molecular weight of at least 80 000 g/mol and a further elastomer selected from natural rubber or styrene-butadiene copolymer. Polyisobutylene and the other elastomer are present in a ratio of from 50 to 70% of polyisobutylene and accordingly from 50 to 30% of other elastomer. The use of these large amounts of polyisobutylene, which does not participate in the crosslinking, leads to a poor compression set.

ExxonMobil Chemical sells polyisobutylene under the name Vistanex® for rubber mixtures based on natural rubber or styrene-butadiene copolymer which are said to be distinguished by improved heat aging behavior, better cracking resistance, improved electrical properties, reduced absorption of water and lower gas permeability. At the same time, the tensile strength and the elongation at break are reduced in the case of these mixtures.

It is the object of the present invention to provide rubber mixtures, in particular for the inner liner of pneumatic vehicle tires, whose vulcanizates are distinguished by reduced plasticizer diffusion and good compression and tension properties.

This object is achieved, according to the invention, if the rubber mixture contains
a) 50 to 100 parts by weight of at least one halobutyl rubber,
b) up to not more than 50 parts by weight of at least one further rubber selected from the group consisting of butyl rubber, polybutadiene, styrene-butadiene copolymer, 3,4-polyisoprene, cis-1,4-polyisoprene, natural rubber, styrene-isoprene copolymer and styrene-isoprene-butadiene terpolymer, the parts by weight of a) and b) summing to 100,
c) 5-45 parts by weight, based on 100 parts by weight of a) and b), of at least one polyisobutylene having a weight average molecular weight M_{w} of more than 400 000 g/mol and
d) 10-120 parts by weight, based on 100 parts by weight of a) and b), of at least one carbon black.

The 5 to 45 parts by weight of a polyisobutylene having a weight average molecular weight M_{w} of more than 400 000 g/mol act as a plasticizer in a mixture which comprises carbon black and contains from 50 to 100 parts by weight of a halobutyl rubber blended with up to 50 parts by weight of a further rubber. Owing to the lack of double bonds in the molecule, the polyisobutylene does not take part in the sulfur crosslinking and is present in the vulcanized mixture as a component which is not chemically bonded. Although the polyisobutylene is not bonded, it surprisingly does not diffuse to a significant extent out of the sulfur-crosslinked vulcanizate. Embrittlement of the vulcanizate does not occur and adjacent components are not adversely affected by diffusing plasticizer. The compression and tensile properties of the vulcanizates remain at the desired level.

The mixtures according to the invention additionally have the advantage that the vulcanizates obtained from the mixtures have a particularly high resistance to fatigue cracking.

In addition, the vulcanizates obtained from the mixtures according to the invention are distinguished by reduced gas permeability. When used as an inner liner in pneumatic vehicle tires, adjacent components are thus exposed to a lower oxidative load and less aging and the tire pressure decreases substantially more slowly. If appropriate, the thickness of the inner liner can be reduced.

The halobutyl rubbers used in the rubber mixture may be chloro- or bromobutyl rubber, which can be used as freshly produced rubbers but also as regenerated material. A particularly high gastightness of the vulcanizates can be achieved if the mixture is based only on halobutyl rubber as the rubber, i.e. contains 100 parts by weight of halobutyl rubber and no further rubber from the group of rubbers mentioned under point b).

In addition to the halobutyl rubbers, the rubber mixture according to the invention may also contain up to 50 parts by weight of a further rubber selected from the group consisting of butyl rubber, polybutadiene, styrene-butadiene copolymer, 3,4-polyisoprene, cis-1,4-polyisoprene, natural rubber, styrene-isoprene copolymer and styrene-isoprene-butadiene terpolymer.

In addition to the polyisobutylene acting as a plasticizer, the rubber mixture according to the invention may also contain small amounts of other plasticizers, for example mineral oil plasticizers. However, it is particularly preferred if the mixture is free of mineral oil plasticizers. In this way, damage to surrounding rubber components by mineral oil plasticizers diffusing in can be avoided in vulcanized products, such as tires. In addition, it is therefore possible to dispense with the mineral oil plasticizers often classed as being ecologically unsafe.

The rubber mixture contains, based on 100 parts by weight of the components a) and b), from 10 to 120 parts by weight of carbon black. The carbon black may be, for example, furnace blacks, thermal blacks, acetylene blacks, channel blacks or lamp blacks, which can also be used as a mixture. For good gastightness and a modulus of elasticity which is not too high, the mixture preferably comprises from 30 to 70 parts by weight, based on 100 parts by weight of the components a) and b).

According to an advantageous further development of the invention, the weight average molecular weight M_{w} of the polyisobutylene is from 450 000 to 3 000 000 g/mol. The diffusing out of plasticizer can thus be minimized while achieving good vulcanizate properties.

In addition to said substances, the rubber mixture according to the invention may contain customary rubber additives in customary amounts. These substances include, for example, antiaging agents, activators, such as, for example, zinc oxide and fatty acids (e.g. stearic acid), waxes, resins, chalk and mastication auxiliaries. In addition to carbon black, the mixture may also contain further fillers, such as aluminas, calcium carbonate, calcium hydroxide, phyllosilicates, chalk, talc, graphite, kaolin, magnesium oxide, magnesium hydroxide, silica, zeolites, etc., in any desired combinations.

The vulcanization is carried out in the presence of sulfur or sulfur donors, it being possible for some sulfur donors simultaneously to act as vulcanization accelerators. Sulfur or sulfur donors is or are added to the rubber mixture in the last mixing step in the amounts known to the person skilled in the art.

Furthermore, the rubber mixture may contain vulcanization-influencing substances, such as vulcanization accelerators, vulcanization retardants and vulcanization activators, in customary amounts for controlling the required time and/or required temperature of the vulcanization and for improving the vulcanizate properties. The vulcanization accelerators may be selected, for example, from the following accelerator groups: thiazole accelerators, such as, for example, benzothiazyl disulfide (MBTS), sulfenamide accelerators, such as, for example, benzothiazyl-2-cyclohexylsulfenamide (CBS), guanidine accelerators, such as, for example, N,N′-diphenylguanidine (DPG), dithiocarbamate accelerators, such as, for example, zinc dibenzyldithiocarbamate, and disulfides. The accelerators can also be used in combination with one another.

It has proven to be advantageous if the rubber mixture is vulcanized with a crosslinking system based on 0.1-7 parts by weight, based on 100 parts by weight of a) and b), of sulfur and from 0.1 to 6 parts by weight, based on 100 parts by weight of a) and b), of at least one vulcanization accelerator.

The rubber mixture according to the invention is prepared in a conventional manner, as a rule a base mixture which contains all constituents with the exception of the vulcanization system (sulfur and vulcanization-influencing substances) first being prepared in one mixing stage or a plurality of mixing stages and the final mixture then being produced by addition of the vulcanization system. The mixture is then further processed, for example by a calendar process, and brought into the appropriate form. The mixture is preferably brought into the form of an inner liner which, in tire construction, is calendered in the customary manner and applied to the drum. The final tire blank is then vulcanized.

The invention is to be explained in more detail with reference to comparative and working examples, which are summarized in Tables 1 and 2.

In the case of all mixture examples contained in Tables 1 and 2, the stated quantity data are parts by weight.

The comparative mixtures are characterized by C and the mixtures according to the invention are characterized by I. In Table 1, different polyisobutylene types were used. In Table 2, the proportion of polyisobutylene in the mixtures was varied.

The mixture was prepared under the usual conditions in two stages in a laboratory tangential mixer. The reaction times until a relative degree of crosslinking of 90% (t₉₀) was reached were determined by monitoring the vulcanization process by means of a rotorless vulcameter according to DIN 53 529. Furthermore, the Mooney viscosities of the mixtures have been determined according to DIN 53 523 using a shearing disk viscometer at 100° C. The glass transition temperature T_{G} was determined by means of DSC (differential scanning calorimetry). Test specimens were produced from all mixtures by vulcanization for 15 minutes under pressure at 160° C., and material properties typical for the rubber industry were determined using these test specimens. The following test methods were used for the tests on test specimens:
plasticizer extraction with acetone in a Soxhlet extraction apparatus over 16 h; the solvent is evaporated from the extract and the extracted residue is weighed after cooling
tensile strength at room temperature according to DIN 53 504
elongation at break at room temperature according to DIN 53 504
stress values at 300% elongation at room temperature according to DIN 53 504
fracture energy density determined in the tensile test according to DIN 53 504, the fracture energy density being the work required until fracture, based on the volume of the sample
Shore A hardness at room temperature and 70° C. according to DIN 53 505
air permeability according to DIN 53 536 at 70° C. air temperature
Monsanto fatigue test (fatigue to failure tester) at 136% elongation and room temperature of fresh test specimens and test specimens aged for 3 days at 100° C. in air.

TABLE 1

| | Units | 1(C) | 2(C) | 3(C) | 4(I) | 5(I) | 6(I) |
|---|---|---|---|---|---|---|---|
| Constituents | | | | | | | |
| Bromobutyl | parts | 100 | 100 | 100 | 100 | 100 | 100 |
| rubber | by wt. | | | | | | |
| Polyiso- | parts | — | — | — | 30 | — | — |
| butylene (M_{w} | by wt. | | | | | | |
| 2 600 000) | | | | | | | |
| Polyiso- | parts | — | — | — | — | 30 | — |
| butylene (M_{w} | by wt. | | | | | | |
| 1 100 000) | | | | | | | |
| Polyiso- | parts | — | — | — | — | — | 30 |
| butylene | by wt. | | | | | | |
| (M_{w} 500 000) | | | | | | | |
| Carbon black | parts | 60 | 60 | 55 | 60 | 60 | 60 |
| N 660 | by wt. | | | | | | |
| Mineral oil | parts | 14 | 0 | 0 | 0 | 0 | 0 |
| plasticizer | by wt. | | | | | | |
| Stearic | parts | 2 | 2 | 2 | 2 | 2 | 2 |
| acid | by wt. | | | | | | |
| Zinc | parts | 4 | 4 | 4 | 4 | 4 | 4 |
| oxide | by wt. | | | | | | |
| Accelerator | parts | 1.2 | 1.2 | 1.2 | 1.2 | 1.2 | 1.2 |
| | by wt. | | | | | | |
| Sulfur | parts | 0.5 | 0.5 | 0.5 | 0.5 | 0.5 | 0.5 |
| | by wt. | | | | | | |
| Properties | | | | | | | |
| t₉₀ | min | 8.1 | 7.9 | 7.9 | 8.0 | 8.2 | 8.0 |
| Mooney ML | — | 54 | 80 | 74 | 76 | 74 | 68 |
| 1 + 4 | | | | | | | |
| T_{G} | ° C. | −61 | −61 | −61 | −63 | −63 | −63 |
| Plasticizer | % by | 8.1 | 1.0 | 1.3 | 1.2 | 1.6 | 1.3 |
| extraction | weight | | | | | | |
| Tensile | MPa | 6.7 | 7.5 | 7.8 | 8.7 | 8.1 | 7.2 |
| strength | | | | | | | |
| Elongation | % | 944 | 850 | 870 | 931 | 944 | 934 |
| at break | | | | | | | |
| Stress value | MPa | 2.33 | 3.8 | 3.43 | 2.64 | 2.49 | 2.32 |
| 300% | | | | | | | |
| Hardness at | Shore A | 48.5 | 54.8 | 52.4 | 46.5 | 45.9 | 45.2 |
| RT | | | | | | | |
| Hardness at | Shore A | 38.2 | 46.2 | 43.6 | 37.7 | 37.1 | 35.7 |
| 70° C. | | | | | | | |
| Fracture | J/cm³ | 29.5 | 34 | 34.8 | 35.9 | 34.3 | 30.5 |
| energy | | | | | | | |
| density | | | | | | | |
| Air | m²/Pa · s | 4.7 · 10⁻¹⁷ | 3.5 · 10⁻¹⁷ | 3.6 · 10⁻¹⁷ | 3.3 · 10⁻¹⁷ | 3.3 · 10⁻¹⁷ | 3.4 · 10⁻¹⁷ |
| permeability | | | | | | | |
| at 70° C. | | | | | | | |
| Monsanto | kcycles | 480 | 150 | 309 | >2 mil. | >2 mil. | >2 mil. |
| fatigue | | | | | | | |
| Monsanto | kcycles | 93 | 21 | 59 | 1868 | 1056 | 912 |
| fatigue | | | | | | | |
| after aging | | | | | | | |

TABLE 2

| | Units | 1(C) | 7(I) | 4(I) | 8(I) |
|---|---|---|---|---|---|
| Constituents | | | | | |
| Bromobutyl | parts | 100 | 100 | 100 | 100 |
| rubber | by wt. | | | | |
| Poly- | parts | — | 20 | 30 | 40 |
| isobutylene | by wt. | | | | |
| (M_{w} | | | | | |
| 2 600 000) | | | | | |
| Carbon | parts | 60 | 60 | 60 | 60 |
| black | by wt. | | | | |
| N 660 | | | | | |
| Mineral oil | parts | 14 | 0 | 0 | 0 |
| plasticizer | by wt. | | | | |
| Stearic acid | parts | 2 | 2 | 2 | 2 |
| | by wt. | | | | |
| Zinc oxide | parts | 4 | 4 | 4 | 4 |
| | by wt. | | | | |
| Accelerator | parts | 1.2 | 1.2 | 1.2 | 1.2 |
| | by wt. | | | | |
| Sulfur | parts | 0.5 | 0.5 | 0.5 | 0.5 |
| | by wt. | | | | |
| Properties | | | | | |
| t₉₀ | min | 8.1 | 8.0 | 8.2 | 8.0 |
| Mooney | — | 54 | 76 | 74 | 68 |
| ML 1 + 4 | | | | | |
| T_{G} | ° C. | −61 | −63 | −63 | −63 |
| Plasticizer | % by | 7.2 | 1.0 | 1.2 | 1.1 |
| extraction | weight | | | | |
| Tensile | MPa | 6.7 | 8.7 | 8.1 | 7.2 |
| strength | | | | | |
| Elongation | % | 944 | 931 | 944 | 934 |
| at break | | | | | |
| Stress value | MPa | 2.33 | 2.64 | 2.49 | 2.32 |
| 300% | | | | | |
| Hardness at RT | Shore A | 48.5 | 46.5 | 45.9 | 45.2 |
| Hardness at | Shore A | 38.2 | 37.7 | 37.1 | 35.7 |
| 70° C. | | | | | |
| Fracture energy | J/cm³ | 29.5 | 35.9 | 34.3 | 30.5 |
| density | | | | | |
| Air | m²/Pa · | 4.7 · 10⁻¹⁷ | 3.3 · 10⁻¹⁷ | 3.3 · 10⁻¹⁷ | 3.4 · 10⁻¹⁷ |
| permeability | s | | | | |
| at 70° C. | | | | | |
| Monsanto | kcycles | 480 | >2 mil. | >2 mil. | >2 mil. |
| fatigue | | | | | |
| Monsanto | kcycles | 93 | 1868 | 1056 | 912 |
| fatigue | | | | | |
| after aging | | | | | |

The tables show that the vulcanizates of the rubber mixtures according to the invention have a very low plasticizer extraction and hence plasticizer diffusion. The danger of tearing due to hardening of the mixture after plasticizer has diffused out is thus prevented. Furthermore, the influencing of adjacent components by plasticizer which escapes from mixtures according to the invention is thus suppressed. The compression and tensile properties of the vulcanizates remain at the desired level or are even improved. The requirement of a hardness at room temperature of less than 50 Shore A, which is important for inner liners, is also met.

Also particularly remarkable is the substantial increase in the resistance to fatigue cracking according to Monsanto with the use of polyisobutylene in the mixtures, which is particularly significant even after heat aging. When used as an inner liner, these mixtures therefore ensure high tire stability.

The gas permeability is also reduced in comparison with mixture 1(C), so that aging effects in the product are reduced by the lower gas diffusion.

1: A sulfur-crosslinkable rubber mixture, in particular for the inner liner of pneumatic vehicle tires, containing
a) 50-100 parts by weight of at least one halobutyl rubber,
b) up to not more than 50 parts by weight of at least one further rubber selected from the group consisting of butyl rubber, polybutadiene, styrene-butadiene copolymer, 3,4-polyisoprene, cis-1,4-polyisoprene, natural rubber, styrene-isoprene copolymer and styrene-isoprene-butadiene terpolymer, the parts by weight of a) and b) summing to 100,
c) 5-45 parts by weight, based on 100 parts by weight of a) and b), of at least one polyisobutylene having a weight average molecular weight M_{w} of more than 400 000 g/mol and
d) 10-120 parts by weight, based on 100 parts by weight of a) and b), of at least one carbon black.

2: The rubber mixture as claimed in claim 1, wherein it contains 100 parts by weight of at least one halobutyl rubber.

3: The rubber mixture as claimed in claim 1, wherein it is free of mineral oil plasticizers.

4: The rubber mixture as claimed in claim 1, wherein it contains 30-70 parts by weight, based on 100 parts by weight of a) and b), of carbon black.

5: The rubber mixture as claimed in claim 1, wherein the weight average molecular weight M_{w} of the polyisobutylene is from 450 000 to 3 000 000 g/mol.

6: The rubber mixture as claimed in claim 1, wherein it is vulcanized with a crosslinking system based on 0.1-7 parts by weight, based on 100 parts by weight of a) and b), of sulfur and from 0.1 to 6 parts by weight, based on 100 parts by weight of a) and b), of at least one vulcanization accelerator.

7: A pneumatic vehicle tire comprising an inner liner which is based on a rubber mixture as claimed in claim 1.
